(19) United States
(12) Patent Application Publication
(10) Pub. No.: US 2018/0302789 A1
(43) Pub. Date: Oct. 18, 2018

(54) COMMUNICATION CONTROL APPARATUS, COMMUNICATION CONTROL METHOD, AND NON-TRANSITORY COMPUTER READABLE MEDIUM STORING COMMUNICATION CONTROL PROGRAM

(71) Applicant: NEC Platforms, Ltd., Kawasaki-shi, Kanagawa (JP)

(72) Inventor: Hiroki FUKASAWA, Kanagawa (JP)

(73) Assignee: NEC Platforms, Ltd., Kawasaki-shi, Kanagawa (JP)

(21) Appl. No.: 15/735,647

(22) PCT Filed: Mar. 31, 2016
(86) PCT No.: PCT/JP2016/001870

§ 371 Date: Dec. 12, 2017

(30) Foreign Application Priority Data
Jul. 7, 2015 (JP) 2015-135813

(51) Int. Cl. H04W 12/06; G06F 17/30; G06F 21/44

(52) U.S. Cl. CPC H04W 12/06; H04W 84/12; G06F 21/44; G06F 17/30864

(57) ABSTRACT

A communication control apparatus according to the present disclosure includes a database configured to store first table information associating first identification information with second identification information, the first identification information being identification information of a terminal according to a first authentication mode, second identification information being identification information of the terminal according to a second authentication mode, and a control unit configured to acquire the second identification information of a terminal requesting a communication request in the second authentication mode and determine whether or not to transmit statistical information with a communication status of the terminal recorded therein to a server based on whether or not the first identification information corresponding to the acquired second identification information is recorded in the database.

### TECHNICAL FIELD

The present disclosure relates to a communication control apparatus, a call control method, and a non-transitory computer readable medium storing a call control program. For example, the present disclosure relates to a communication control apparatus, a call control method, and a non-transitory computer readable medium storing a call control program for coping with authentication according to a plurality of communication modes and controlling a connection of a terminal to a network.

### BACKGROUND ART

In recent years, it has been possible to perform network communication in various places by using a public wireless LAN, a home wireless LAN constructed in a house, and the like. The public wireless LAN provides communication environments to specific users with whom a telecommunications carrier has contracts. Meanwhile, the home wireless LAN is constructed by a user himself/herself by installing a communication control apparatus (e.g., a wireless LAN router) in his/her house. Further, in some cases, a telecommunications carrier provides a wireless LAN router used to construct a home wireless LAN as a part of its service. Further, they also provide a communication environment for a terminal that uses a public wireless LAN so that it can cope with both the home wireless LAN and the public wireless LAN.

In a communication control apparatus that is provided to a user by a telecommunications carrier and supports a plurality of authentication modes as described above, it is conceivable that it is necessary to acquire a communication status of a terminal when the terminal is authenticated by one authentication mode and a communication status of that terminal when the terminal is authenticated by another authentication mode. This is because the telecommunications carrier desires to recognize the communication status for each authentication mode and thereby to recognize the degree of a decrease in communication load on its own network that is achieved by providing the communication control apparatus.

Patent Literature 1 discloses a communication network system in which each of a plurality of access points includes a station list management unit that manages a station list holding information about a plurality of stations, and a control unit that controls the station list management unit. In this communication network system, the plurality of access points mutually exchange station lists that they hold among the access points and, by doing so, create station lists having common contents. Further, when a given access point receives a frame signal and the destination of that frame signal is not the access point itself, it refers to its own station list based on information contained in the frame signal. Then, if the destination is a terminal managed by other access points, the access point transfers the frame signal to the terminal.

### CITATION LIST

### Patent Literature

Patent Literature 1: Japanese Unexamined Patent Application Publication No. 2000-269968

### SUMMARY OF INVENTION

### Technical Problem

In the communication network system disclosed in Patent Literature 1, when a frame signal received from a terminal is not addressed to the access point itself, the access point can transmit the received frame signal to other access points. However, this communication network system does not summarize information as to which authentication mode is used for the received frame signal and does not transmit summarized information as statistical information to the server. Therefore, it cannot recognize the volume of communication performed through this access point regardless of whether frame signals are addressed to the access point itself or not.

### Solution to Problem

An aspect of a communication control apparatus according to the present disclosure includes: a database configured to store first table information associating first identification information with second identification information, the first identification information being identification information of a terminal in a first authentication mode, second identification information being identification information of the terminal in a second authentication mode; and a control unit configured to acquire the second identification information of a terminal requesting a communication request in the second authentication mode and determine whether or not to transmit statistical information with a communication status of the terminal recorded therein to a server based on whether or not the first identification information corresponding to the acquired second identification information is recorded in the database.

An aspect of a communication control method according to the present disclosure is a communication control method performed in a communication control apparatus, the communication control apparatus including a storage unit configured to store a database and a control unit configured to control communication, the communication control apparatus being configured to support a plurality of authentication modes, give a connection permission to a terminal based on each authentication mode, and control network communication performed by the terminal to which a permission is given, the communication control method including: generating first table information associating first identification information with second identification information and storing the generated first table information in the database, the first identification information being terminal identification information in a first authentication mode of a terminal to which a permission is given in the first authentication mode, second identification information being terminal identification information in a second authentication mode of the terminal; and acquiring the second identification information from a terminal that has made a communication request in the second authentication mode, and determining whether or not to transmit statistical information with a communication status of the terminal recorded therein to a server based on whether or not the first identification information corresponding to the second identification information is recorded in the first table information.

An aspect of a non-transitory computer readable medium storing a communication control program according to the present disclosure is a non-transitory computer readable medium storing a communication control program, the communication control program being adapted to be executed in a communication control apparatus, the communication control apparatus including a storage unit configured to store a database and an arithmetic unit configured to execute a program for controlling communication, the communication control apparatus being configured to support a plurality of authentication modes, give a connection permission to a terminal based on each authentication mode, and control network communication performed by the terminal to which a permission is given, the communication control program being adapted to cause the communication control apparatus to: generate first table information associating first identification information with second identification information and store the generated first table information in the database, the first identification information being terminal identification information in a first authentication mode of a terminal to which a permission is given in the first authentication mode, second identification information being terminal identification information in a second authentication mode of the terminal; and acquire the second identification information from a terminal that has made a communication request in the second authentication mode and determine whether or not to transmit statistical information with a communication status of the terminal recorded therein to a server based on whether or not the first identification information corresponding to the second identification information is recorded in the first table information.

### Advantageous Effects of Invention

According to the communication control apparatus, the call control method, and the call control program in accordance with the present disclosure, when a terminal capable of performing communication in either of first and second authentication modes has made a communication request in the second authentication mode, it is possible to change a communication condition.

### BRIEF DESCRIPTION OF DRAWINGS

FIG. 1 is a block diagram of a communication system including a communication control apparatus according to a first embodiment;

FIG. 2 shows an example of an identification information reference table stored in a database of the communication control apparatus according to the first embodiment; and

FIG. 3 is a flowchart for explaining an operation performed by according to the first embodiment.

### DESCRIPTION OF EMBODIMENTS

### First Embodiment

Embodiments according to the present disclosure are explained hereinafter with reference to the drawings. For clarifying the explanation, the following descriptions and the drawings are partially omitted and simplified as appropriate. The same symbols are assigned to the same elements throughout the drawings, and duplicated explanations are omitted as necessary.

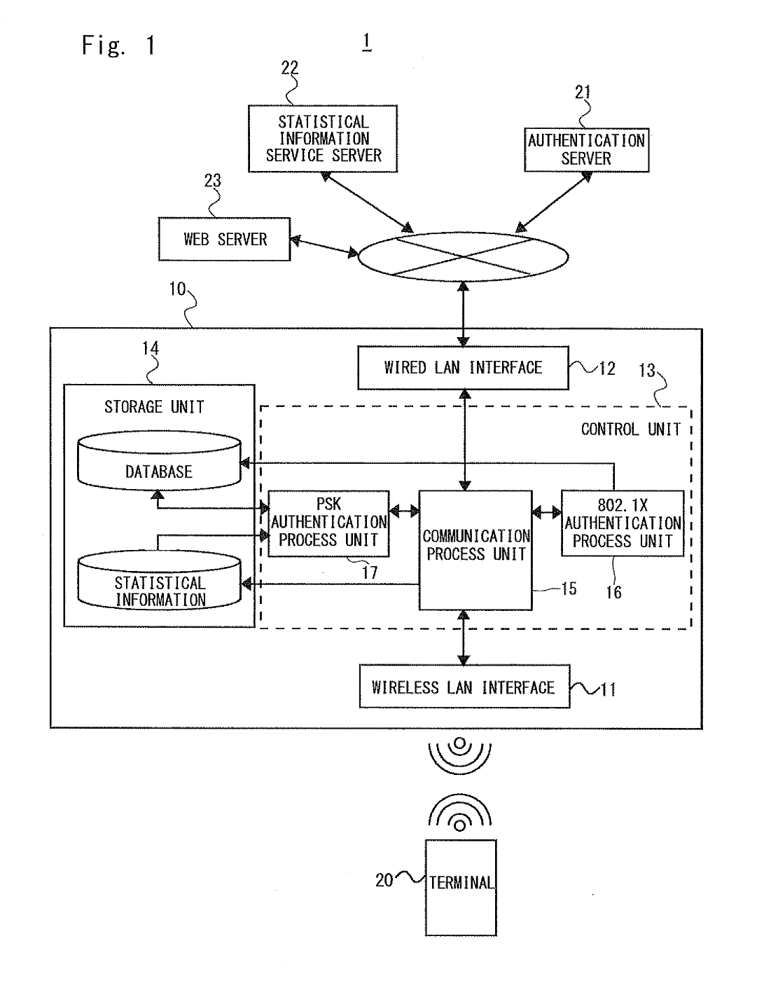

Firstly, FIG. 1 shows a block diagram of a communication system 1 according to a first embodiment. As shown in FIG. 1, in the communication system 1 according to the first embodiment, a terminal 20 accesses a server such as a web server 23 disposed in a public network through a communication control apparatus 10. Further, in the communication system 1 shown in FIG. 1, an authentication server 21 and a statistical information service server 22 are provided in the public network. Details of the authentication server 21 and the statistical information service server 22 will be described later. The communication control apparatus 10 controls a connection of the terminal 20 to the network.

Further, the communication control apparatus 10 performs an authentication process in a plurality of authentication modes when the terminal 20 connects to the network. In examples explained below, the communication control apparatus 10 supports an authentication mode based on an IEEE802.1X authentication mode (hereinafter referred to as a first authentication mode) and an authentication mode based on a PSK (Pre Shared Key) authentication mode (hereinafter referred to as a second authentication mode). Further, the communication control apparatus 10 permits the terminal 20 that supports at least one of the first and second authentication modes to connect to the network. Note that the authentication modes that the communication control apparatus 10 supports are not limited to the aforementioned two authentication modes.

The first and second authentication modes are explained hereinafter. In the communication control apparatus 10 according to the first embodiment, an IEEE802.1X authentication mode is adopted as the first authentication mode. In the IEEE802.1X authentication mode, an authentication process in which permission/refusal of a connection is determined by using individual authentication information, such as an ID and a password, for each user is performed. Further, in the IEEE802.1X authentication mode, the communication control apparatus 10 asks the authentication server 21 about an ID and a password received from the terminal 20 and, by doing so, performs the authentication process. That is, in the IEEE802.1X authentication mode, permission/refusal of a connection is determined for each set of an ID and a password that is assigned to a user in advance. Further, in the IEEE802.1X authentication mode, a CUI (Chargeable-User-Identity) indicating the unit of billing is associated with an ID transmitted from the terminal 20 in order to manage the traffic volume for each CUI.

Further, in the communication control apparatus 10 according to the first embodiment, a PSK authentication mode is adopted as the second authentication mode. In the PSK authentication mode, the communication control apparatus 10 determines a common password for permitting a connection to the network in advance and the terminal 20 requests the communication control apparatus 10 to permit the connection by using this common password. That is, in the PSK authentication mode, an objective of the authentication process is to determine whether or not the common password transmitted from the terminal 20 matches the determined common password. Further, in the PSK authentication mode, terminals 20 to be connected are managed by using MAC (Media Access Control) addresses identifying the terminals.

In the communication system 1 according to the first embodiment shown in FIG. 1, when the terminal 20 that can connect to the network in the first authentication mode is permitted to connect to the network in the second authentication mode and performs communication, a communication condition of the terminal 20 is changed. In this example, it is assumed that the communication condition to be changed includes at least one of a change of an authentication mode used for communication, a change of a communication path, and a change of an operation that is performed inside the communication control apparatus during communication.

More specifically, when the terminal 20 that can connect to the network in the first authentication mode is permitted to connect to the network in the second authentication mode and performs communication, it acquires statistical information of communication based on the second authentication mode (e.g., information for recognizing a communication status such as a traffic volume and a communication time), associates this statistical information with first identification information corresponding to the terminal 20, and transmits the associated information to the statistical information service server 22. In this way, the telecommunications carrier can specify a CUI based on the first identification information contained in the statistical information transmitted to the statistical information service server 22 and hence is able to collect the statistical information of the terminal 20 without associating the MAC address of the terminal 20 with the CUI in the server.

Further, since the communication control apparatus 10 according to the first embodiment performs control so that the terminal 20 that is determined to be able to connect to the network in the first authentication mode performs communication based on the second authentication mode instead of the first authentication mode, it can reduce the communication load on the network in which communication is performed based on the first authentication mode (e.g., IEEE802.1X).

In the communication control apparatus 10 according to the first embodiment, the communication condition of the terminal 20 is changed as described above. Therefore, the communication control apparatus 10 according to the first embodiment is explained hereinafter in a more detailed manner.

As shown in FIG. 1, the communication control apparatus 10 includes a wireless LAN interface 11, a wired LAN interface 12, a control unit 13, and a storage unit 14. Note that the wired LAN interface 12 may be an interface by which the communication control apparatus can reach a higher-layer network, such as a mobile communication interface by which the communication control apparatus communicates with a base station by using a radio signal.

The communication control apparatus 10 communicates with the terminal 20 through the wireless LAN interface 11. Further, the communication control apparatus 10 communicates with a server located in a public network through the wired LAN interface 12. Further, in the communication control apparatus 10, the control unit 13 controls communication data that are transmitted/received between the wireless LAN interface 11 and the wired LAN interface 12. Further, the control unit 13 performs a process related to a change of a communication condition performed by the communication control apparatus 10. Note that the communication control apparatus 10 communicates with the public network by using the wired LAN interface. However, the interface by which the communication control apparatus 10 communicates with the public network may be either a wired interface or a wireless network, provided that the communication control apparatus 10 can reach the higher-layer network through the interface.

The control unit 13 can be implemented by, for example, an arithmetic unit capable of executing a program, such as a CPU (Central Processing Unit). Further, the control unit 13 may be implemented by forming required functions by hardware. In the following explanation, only the parts that are characteristic of the control unit 13 are shown as processing blocks. These processing blocks can be implemented by either software or hardware. Further, in the following explanation, it is assumed that a program executed by the control unit 13 is a communication control program for implementing functions of the processing blocks shown inside the control unit 13.

Note that the aforementioned program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

In the communication control apparatus 10 according to the first embodiment, various functions can be implemented by using the control unit 13 and the storage unit 14. In the storage unit 14, a database and statistical information are stored. In the database, first table information (e.g., an identification information reference table) that associates first identification information (hereinafter referred to as a user identifier) that is identification information of a terminal in the first authentication mode (e.g., an IEEE802.1X authentication mode) with second identification information (hereinafter referred to as a terminal identifier) that is identification information of the terminal in the second authentication mode (e.g., a PSK authentication mode) is stored.

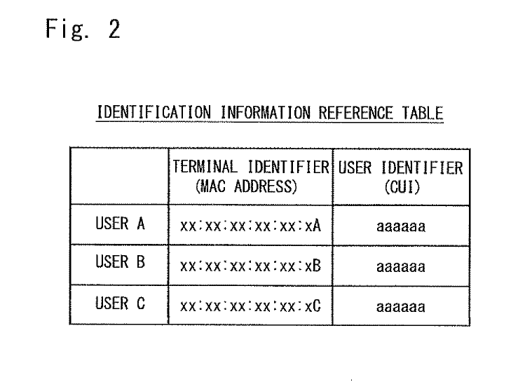

Here, FIG. 2 shows an example of the identification information reference table. In the example shown in FIG. 2, users A to C are the same user or have the same user identifier, and use three different terminals. Therefore, in the identification information reference table shown in FIG. 2, different terminal identifiers (e.g., MAC addresses) are associated with the same user identifier (e.g., a CUI).

The control unit 13 acquires a terminal identifier (e.g., a MAC address) from a terminal that has made a communication request in the second authentication mode and changes a communication condition for the terminal 20 that has made the communication request based on whether or not a user identifier corresponding to the terminal identifier is recorded in the identification information reference table.

When a communication request based on the second authentication mode is made from a terminal whose user identifier is present in the identification information reference table, the control unit 13 starts communication with the terminal 20 that the control unit 13 has permitted to perform communication based on the second authentication mode.

When the control unit 13 performs communication based on the second authentication mode, the control unit 13 stores statistical information indicating a communication state of the terminal 20 that the control unit 13 has permitted to perform communication in association with its user identifier and outputs information that associates the stored statistical information with the user identifier corresponding to statistical information to be transmitted.

When the terminal 20 has made a communication request in the first authentication mode, the control unit 13 performs an authentication process based on a user identifier, associates the user identifier of the terminal 20 that has been permitted by the authentication process with a terminal identifier, and stores the associated user identifier and the terminal identifier in the identification information reference table.

To perform the above-described process, the control unit 13 includes a communication process unit 15, an 802.1X authentication process unit 16, and a PSK authentication process unit 17. The communication process unit 15 performs a main process for controlling communication performed by the communication control apparatus 10, such as a process for exchanging communication data that is transmitted/received between the wireless LAN interface 11 and the wired LAN interface 12 and sequence control for a connection authentication process. This main process includes at least switching of communication paths based on a result of authentication performed by the 802.1X authentication process unit 16 and the PSK authentication process unit 17. Further, the communication process unit 15 acquires statistical information of the terminal 20 by monitoring communication between the wireless LAN interface 11 and the wired LAN interface 12, and accumulates the acquired statistical information in statistical information stored in the storage unit 34. Note that the communication control apparatus 10 is equipped with a counter or the like that acquires a traffic volume or the like for a terminal connected to the communication control apparatus as statistical information thereof irrespective of whether or not the terminal supports a plurality of communication modes. Therefore, the communication control apparatus 10 can carry out the monitoring of communication between the wireless LAN interface 11 and the wired LAN interface 12 by using statistical information acquisition means such as the aforementioned counter. That is, there is no need to newly add any special means for monitoring communication to acquire the statistical information in the communication control apparatus 10.

The 802.1X authentication process unit 16 performs a specific process of the authentication process based on the first authentication mode. Specifically, when the terminal 20 issues an authentication request based on the first authentication mode to the communication control apparatus 10, the 802.1X authentication process unit 16 generates a first authentication packet including a user identifier received from the terminal 20 and requests the authentication server 21 to perform an authentication process for the terminal 20. Further, the 802.1X authentication process unit 16 receives a result of the authentication performed by the authentication server 21 and instructs the communication process unit 15 to perform a subsequent specific process based on the authentication result. Further, when the terminal 20 is authenticated so that it can connect to the network, the 802.1X authentication process unit 16 associates the user identifier of the terminal 20 with a terminal identifier and records the associated user identifier and the terminal identifier in the identification information reference table in the database.

The PSK authentication process unit 17 performs a specific process of the authentication process based on the second authentication mode. Specifically, when the terminal 20 issues an authentication request based on the second authentication mode to the communication control apparatus 10, the PSK authentication process unit 17 performs an authentication process using a common password received from the terminal 20. Further, the PSK authentication process unit 17 transmits information that associates the statistical information accumulated in the storage unit 34 with a user identifier in the database to the statistical information service server 22 through the communication process unit 15 in response to a request from the statistical information service server 22, in a predetermined transmission cycle, or when the data volume of the statistical information accumulated in the storage unit 34 becomes equal to or larger than a predetermined transmission threshold volume.

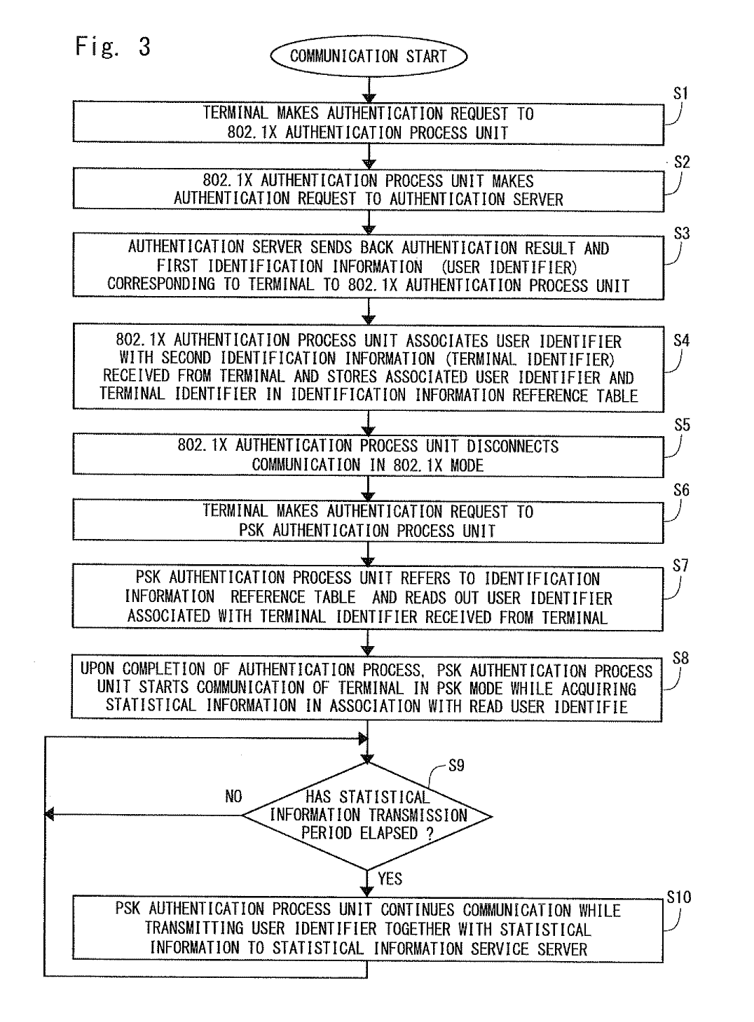

Next, an operation performed by the communication control apparatus 10 according to the first embodiment is explained in detail. Therefore, FIG. 3 shows a flowchart for exampling an operation performed by the communication control apparatus 10 according to the first embodiment.

In the communication system 1 according to the first embodiment, firstly, the terminal 20 makes an authentication request based on the first authentication mode to the communication control apparatus 10 (step S1). Then, upon receiving the authentication request based on the first authentication mode from the terminal 20, the communication control apparatus 10 transfers this authentication request to the 802.1X authentication process unit 16. The 802.1X authentication process unit 16 makes an authentication request to the statistical information service server 22 based on the authentication request received from the terminal 20 (step S2).

Next, the statistical information service server 22 sends back a user identifier that is given by the authentication server based on the authentication result and authentication information in the authentication request made by the terminal 20 to the 802.1X authentication process unit 16 (step S3). Then, upon receiving the authentication result, the 802.1X authentication process unit 16 associates the user identifier received from the statistical information service server 22 with a terminal identifier received from the terminal 20 and records the associated user identifier and the terminal identifier in the identification information reference table in the database in the storage unit 14 (step S4). In this way, the user identifier corresponding to the terminal identifier of the terminal 20 is registered in the identification information reference table. Further, in the communication control apparatus 10 according to the first embodiment, after the step S4, the 802.1X authentication process unit 16 instructs the communication process unit 15 to disconnect communication based on the first authentication mode and the communication process unit 15 disconnects the communication based on the first authentication mode according to this instruction (step S5). This process in the step S5 does not necessarily have to be performed.

Next, when the terminal 20 makes an authentication request based on the second authentication mode to the PSK authentication process unit 17 of the communication control apparatus 10, it starts an authentication process in a step S6. Then, when the authentication process is completed with a result indicating that the terminal 20 can connect to the network in the PSK authentication process unit 17, the PSK authentication process unit 17 refers to the identification information reference table in the database and reads out the user identifier associated with the terminal identifier received from the terminal 20 (step S7). After that, upon the completion of the above-described authentication process, the communication process unit 15 starts communication of the terminal based on the second authentication mode while acquiring statistical information in association with the read user identifier (step S8).

Note that the communication control apparatus 10 can omit the inquiring process to the authentication server (the steps S2 to S4) in the authentication process based on the first authentication mode. For example, the communication control apparatus 10 can be configured so that by registering the terminal identifier of the terminal 20 and the user identifier corresponding to this terminal identifier in the identification information reference table, the communication control apparatus 10 uses this registered information later. In this case, the communication control apparatus 10 determines that the first authentication process has succeeded based on the presence of the user identifier associated with the terminal identifier in the identification information reference table without inquiring of the authentication server about the authentication process based on the first authentication mode. After that, the 802.1X authentication process unit 16 instructs the communication process unit 15 to disconnect communication based on the first authentication mode and the communication process unit 15 disconnects the communication based on the first authentication mode according to this instruction (step S5). Further, the 802.1X authentication process unit 16 resumes the communication according to the authentication request that is made by the terminal 20 based on the second authentication mode.

In the example shown in FIG. 3, while the PSK authentication process unit 17 transmits the user identifier together with the statistical information to the statistical information service server 22 in a predetermined statistical information transmission cycle (e.g., a statistical information transmission cycle preset by a manufacture at the time of shipment of the communication control apparatus 10), the communication process unit 15 continues the communication (steps S9 and S10).

As explained above, the communication control apparatus 10 according to the first embodiment has, in the database, the identification information reference table in which user identifiers for identifying users in the first authentication mode and terminal identifiers for identifying terminals 20 are recorded while being associated with each other. In this way, the communication control apparatus 10 can recognize the status of communication performed in the second authentication mode in the communication control apparatus by collecting the status of communication performed in the second authentication mode and transmitting it to the server.

Further, the communication control apparatus 10 according to the first embodiment changes a communication path of the terminal 20 that can connect to the network based on the first authentication mode to a communication path based on the second authentication mode by referring to the identification information reference table. In this way, the communication control apparatus 10 according to the first embodiment can reroute some communication load on the network that is used for communication based on the first authentication mode to the network that is used for communication based on the second authentication mode and thereby reduce the communication load on the network used for communication based on the first authentication mode.

Further, since the communication control apparatus 10 according to the first embodiment has the identification information reference table, it can accumulate statistical information of communication performed by the terminal 20 that is started based on the second authentication mode in association with the user identifier of the terminal 20. As an example, if the communication control apparatus 10 does not has the identification information reference table, it is necessary to construct a database that associates user identification information with terminal identification information between the authentication server 21 and the statistical information service server 22. In contrast to this, the communication control apparatus 10 according to the first embodiment accumulates statistical information of communication performed by the terminal 20 that is started based on the second authentication mode in association with the user identifier of the terminal 20 and transmits information obtained by accumulating these information pieces to the statistical information service server 22. By doing so, the communication control apparatus 10 can recognize the communication status, such as the traffic volume of communication that is performed by a specific user based the second authentication mode, based solely on the information that the statistical information service server 22 has received. That is, by using the communication control apparatus 10 according to the first embodiment, it is possible to reduce a work load necessary for constructing a system that enables a telecommunications carrier having the authentication server 21 and the statistical information service server 22 to recognize communication statuses related to users. Further, by using communication control apparatuses 10 according to the first embodiment, the telecommunications carrier can reduce the cost for constructing the system and easily recognize the traffic volume that can be offloaded from the mobile communication network to home wireless LANs by installing the communication control apparatuses 10.

In particular, in recent years, the number of communication terminals such as smartphones is increasing and communication loads on mobile communications networks are increasing. To cope with the increase, telecommunications carriers are promoting installation of wireless LAN access points and effectively increasing the communication traffic volume that are offloaded by wireless LAN communication. Note that by recognizing offloaded communication traffic volume based on statistical information, it is possible to increase the efficiency of the wireless LAN access points. Therefore, it is increasingly desired to collect statistical information that enables telecommunications carriers to recognize the offloaded communication traffic volume at a low cost. In this disclosure, it is possible to collect the offloaded communication traffic volume even when each terminal is connected in any authentication mode in wireless LAN communication.

Note that the present disclosure is not limited to the above-described embodiments and various modifications may be made therein without departing from the spirit and scope of the present disclosure.

This application is based upon and claims the benefit of priority from Japanese patent application No. 2015-135813, filed on Jul. 7, 2015, the disclosure of which is incorporated herein in its entirety by reference.

### REFERENCE SIGNS LIST

1 COMMUNICATION SYSTEM
10 COMMUNICATION CONTROL APPARATUS
11 WIRELESS LAN INTERFACE
12 WIRED LAN INTERFACE
13 CONTROL UNIT
14 STORAGE UNIT
15 COMMUNICATION PROCESS UNIT
16 802.1X AUTHENTICATION PROCESS UNIT
17 PSK AUTHENTICATION PROCESS UNIT
20 TERMINAL
21 AUTHENTICATION SERVER
22 STATISTICAL INFORMATION SERVICE SERVER
23 WEB SERVER

What is claimed is:

1. A communication control apparatus comprising:
a database configured to store first table information associating first identification information with second identification information, the first identification information being identification information of a terminal in a first authentication mode, second identification information being identification information of the terminal in a second authentication mode; and
control means for acquiring the second identification information of a terminal requesting a communication request in the second authentication mode and determining whether or not to transmit statistical information with a communication status of the terminal recorded therein to a server based on whether or not the first identification information corresponding to the acquired second identification information is recorded in the database.

2. The communication control apparatus according to claim 1, wherein when a communication request based on the first authentication mode is made from a terminal whose first identification information is present in the first table information, the control means stops communication with the terminal based on the first authentication mode and starts communication with the terminal based on the second authentication mode.

3. The communication control apparatus according to claim 1, wherein
when communication is performed based on the second authentication mode,
the control means stores statistical information indicating a communication state of the terminal that the control means has permitted to perform communication in association with the first identification information, and
the control means outputs information associating the stored statistical information with the first identification information corresponding to the statistical information to be transmitted.

4. The communication control apparatus according to claim 1, wherein
when the terminal has made a communication request in the first authentication mode, the control means performs an authentication process based on the first identification information, and
the control means associates the first identification information of the terminal that has been permitted by the authentication process with the second identification information and stores the associated first and second identification information in the first table information.

5. A communication control method performed in a communication control apparatus, the communication control apparatus comprising storage means for storing a database and control means for controlling communication, the communication control apparatus being configured to support a plurality of authentication modes, give a connection permission to a terminal based on each authentication mode, and control network communication performed by the terminal to which a permission is given,
the communication control method comprising:
generating first table information associating first identification information with second identification information and storing the generated first table information in the database, the first identification information being terminal identification information in a first authentication mode of a terminal to which a permission is given in the first authentication mode, second identification information being terminal identification information in a second authentication mode of the terminal; and
acquiring the second identification information from a terminal that has made a communication request in the second authentication mode, and
determining whether or not to transmit statistical information with a communication status of the terminal recorded therein to a server based on whether or not the first identification information corresponding to the second identification information is recorded in the first table information.

6. A non-transitory computer readable medium storing a communication control program, the communication control program being adapted to be executed in a communication control apparatus, the communication control apparatus comprising storage means for storing a database and control means for executing a program for controlling communication, the communication control apparatus being configured to support a plurality of authentication modes, give a connection permission to a terminal based on each authentication mode, and control network communication performed by the terminal to which a permission is given,
the communication control program being adapted to cause the communication control apparatus to:
generate first table information associating first identification information with second identification information and store the generated first table information in the database, the first identification information being terminal identification information in a first authentication mode of a terminal to which a permission is given in the first authentication mode, second identification information being terminal identification information in a second authentication mode of the terminal; and
acquire the second identification information from a terminal that has made a communication request in the second authentication mode and determine whether or not to transmit statistical information with a communication status of the terminal recorded therein to a server based on whether or not the first identification information corresponding to the second identification information is recorded in the first table information.
